(19) United States
(12) Patent Application Publication
(10) Pub. No.: US 2023/0291462 A1
(43) Pub. Date: Sep. 14, 2023

(54) COMMUNICATION SYSTEM

(71) Applicant: NOKIA TECHNOLOGIES OY, ESPOO (FI)

(72) Inventors: Tero Johannes IHALAINEN, Nokia (FI); Martti Johannes MOISIO, Klaukkala (FI); Mikko Aleksi UUSITALO, Helsinki (FI); Karthik UPADHYA, Espoo (FI)

(21) Appl. No.: 17/791,766

(22) PCT Filed: Jan. 6, 2020
(86) PCT No.: PCT/EP2020/050139

§ 371 Date: Jul. 8, 2022

(51) Int. Cl. H04B 7/185; G05D 1/10

(52) U.S. Cl. CPC H04B 7/18504; G05D 1/104

(57) ABSTRACT

An apparatus, method and computer program is described comprising: determining a first desired formation for a plurality of objects in accordance with a communication performance algorithm, wherein the plurality of objects are in communication with a first communication node; and instructing the objects of the plurality to move to respective object positions of the first desired formation in a first mode of operation.

### FIELD

The present specification relates to a communication system. In particular, to communication systems in which a plurality of objects are in communication with a communication node, such as a base station.

### BACKGROUND

Communication systems in which a plurality of objects, such as unmanned aerial vehicles (UAVs), are in communication with a communication node, such as a base station, are known. However, there remains a need for further developments in this field.

### SUMMARY

In a first aspect, this specification describes an apparatus comprising means for performing: determining a first desired formation for a plurality of objects in accordance with a communication performance algorithm, wherein the plurality of objects are in communication with a first communication node; and instructing the objects of the plurality to move to respective object positions of the first desired formation in a first mode of operation (such as a data transfer mode of operation). The first formation may, for example, be desired in order to improve spatial multiplexing and/or to improve spectral efficiency.

Determining the first desired formation may comprise optimising locations of the plurality of objects in accordance with one or more of functions, examples of which are outlined below. For example, determining the first desired formation may comprise optimising locations of the plurality of objects such that a total spectral efficiency of all of said objects is maximised. Alternatively, or in addition, determining the first desired formation may comprise optimising locations of the plurality of objects such that the spectral efficiency of an object of the plurality with the lowest data throughput is maximised. Alternatively, or in addition, determining the first desired formation may comprise optimising locations of the plurality of objects such that a spectral efficiency of each object is above a threshold level. Alternatively, or in addition, determining the first desired formation may comprise setting the first desired formation of the plurality of objects such that each of the plurality of objects is spatially resolvable by the first communication node.

In some example embodiments, the means for determining the first desired formation is constrained by movement restraint limits of one or more of the plurality of objects.

Some example embodiments include dividing the objects into two or more groups, wherein each of said groups are in communication with a different communication node. This may be done, for example, if it is not possible to set object positions so that they are all spatially resolvable by a single communication node.

In some example embodiments, the means may be further configured to perform: instructing the objects to move to respective object positions in accordance with a flight plan in a second mode of operation (e.g. a normal mode of operation, such as when a data transfer mode of operation is complete).

Each object position may comprise an azimuth angle and an elevation angle of the respective object relative to the first communication node. The object position may also be based on a distance from the communication node. The azimuth and elevation angles may define an angle of arrival of communications between the communication node and the relevant object.

In some example embodiments, the means may be further configured to perform: communicating between the first communication node and the plurality of objects using a MIMO algorithm (e.g. a M-MIMO algorithm). The first communication node may, for example, be a MIMO communication node having a plurality of spatially separated channels.

The plurality of objects may comprise unmanned aerial vehicles (UAVs). Alternatively, or in addition, the plurality of objects may comprise unmanned ground vehicles and/or robots.

The first communication node may communicate with the plurality of objects using spatial multiplexing (e.g. such that different objects within the plurality may be served by different MIMO beams). Thus, the same time and frequency resources may be used for each transmission. This is possible if each of the plurality of objects being communicated with are spatially separated, for example such that they are within different beams of a MIMO antenna of the communication node.

The said means may comprise: at least one processor; and at least one memory including computer program code, the at least one memory and the computer program code configured, with the at least one processor, to cause the performance of the apparatus.

In a second aspect, this specification describes a method comprising: determining a first desired formation (e.g. desired in order to improve spatial multiplexing and/or to improve spectral efficiency) for a plurality of objects (e.g. unmanned aerial vehicles) in accordance with a communication performance algorithm, wherein the plurality of objects are in communication with a first communication node; and instructing the objects of the plurality to move to respective object positions of the first desired formation in a first mode of operation (such as a data transfer mode of operation).

Determining the first desired formation may comprise optimising locations of the plurality of objects such that a total spectral efficiency of all of said objects is maximised. Alternatively, or in addition, determining the first desired formation may comprise optimising locations of the plurality of objects such that the spectral efficiency of an object of the plurality with the lowest data throughput is maximised.

Alternatively, or in addition, determining the first desired formation may comprise optimising locations of the plurality of objects such that a spectral efficiency of each object is above a threshold level. Alternatively, or in addition, determining the first desired formation may comprise setting the first desired formation of the plurality of objects such that each of the plurality of objects is spatially resolvable by the first communication node.

Some example embodiments include dividing the objects into two or more groups, wherein each of said groups are in communication with a different communication node. This may be done, for example, if it is not possible to set object positions so that they are all spatially resolvable by a single communication node.

Some example embodiments include instructing the objects to move to respective object positions in accordance with a flight plan in a second mode of operation (e.g. a normal mode of operation, such as when a data transfer mode of operation is complete).

Some example embodiments include communicating between the first communication node and the plurality of objects using a MIMO algorithm.

The first communication node may communicate with the plurality of objects using spatial multiplexing (e.g. such that different objects within the plurality may be served by different MIMO beams).

In a third aspect, this specification describes an apparatus configured to perform any method as described with reference to the second aspect.

In a fourth aspect, this specification describes computer-readable instructions which, when executed by computing apparatus, cause the computing apparatus to perform any method as described with reference to the second aspect.

In a fifth aspect, this specification describes a computer program comprising instructions for causing an apparatus to perform at least the following: determining a first desired formation (e.g. desired in order to improve spatial multiplexing and/or to improve spectral efficiency) for a plurality of objects (e.g. unmanned aerial vehicles) in accordance with a communication performance algorithm, wherein the plurality of objects are in communication with a first communication node; and instructing the objects of the plurality to move to respective object positions of the first desired formation in a first mode of operation (such as a data transfer mode of operation).

In a sixth aspect, this specification describes a computer-readable medium (such as a non-transitory computer-readable medium) comprising program instructions stored thereon for performing at least the following: determining a first desired formation (e.g. desired in order to improve spatial multiplexing and/or to improve spectral efficiency) for a plurality of objects (e.g. unmanned aerial vehicles) in accordance with a communication performance algorithm, wherein the plurality of objects are in communication with a first communication node; and instructing the objects of the plurality to move to respective object positions of the first desired formation in a first mode of operation (such as a data transfer mode of operation).

In a seventh aspect, this specification describes an apparatus comprising: at least one processor; and at least one memory including computer program code which, when executed by the at least one processor, causes the apparatus to: determine a first desired formation (e.g. desired in order to improve spatial multiplexing and/or to improve spectral efficiency) for a plurality of objects (e.g. unmanned aerial vehicles) in accordance with a communication performance algorithm, wherein the plurality of objects are in communication with a first communication node; and instruct the objects of the plurality to move to respective object positions of the first desired formation in a first mode of operation (such as a data transfer mode of operation).

In an eighth aspect, this specification describes an apparatus comprising: a first control module (e.g. a flight plan control module) for determining a first desired formation for a plurality of objects (e.g. unmanned aerial vehicles (UAVs), unmanned ground vehicles and/or robots) in accordance with a communication performance algorithm, wherein the plurality of objects are in communication with a first communication node; and an output (e.g. a communication signal, for example as part of a MIMO protocol) for instructing the objects of the plurality to move to respective object positions of the first desired formation in a first mode of operation (such as a data transfer mode of operation). The first formation may, for example, be desired in order to improve spatial multiplexing and/or to improve spectral efficiency. The first control module may determine the first desired formation by optimising locations of the plurality of objects in accordance with one or more of functions. A second control module (or the first control module) may instruct the objects to move to respective object positions in accordance with a flight plan in a second mode of operation (e.g. a normal mode of operation, such as when a data transfer mode of operation is complete).

### BRIEF DESCRIPTION OF THE DRAWINGS

Example embodiments will now be described, by way of example only, with reference to the following schematic drawings, in which:

FIGS. 1 and 2 are block diagrams of systems in accordance with example embodiments;

FIGS. 3 and 4 are flow charts showing algorithms in accordance with example embodiments;

FIGS. 5 and 6 are plots showing principles in accordance with example embodiments;

FIG. 7 is a flow chart showing an algorithm in accordance with an example embodiment;

FIG. 8 is a block diagram of a system in accordance with an example embodiment.

FIG. 9 is a flow chart showing an algorithm in accordance with an example embodiment;

FIG. 10 is a block diagram of components of a system in accordance with an example embodiment; and

FIGS. 11A and 11B show tangible media, respectively a removable non-volatile memory unit and a Compact Disc (CD) storing computer-readable code which when run by a computer perform operations according to example embodiments.

### DETAILED DESCRIPTION

The scope of protection sought for various embodiments of the invention is set out by the independent claims. The embodiments and features, if any, described in the specification that do not fall under the scope of the independent claims are to be interpreted as examples useful for understanding various embodiments of the invention.

In the description and drawings, like reference numerals refer to like elements throughout.

The use of unmanned aerial vehicles (UAVs), also commonly referred to as drones, for different civilian applications is increasing. UAVs may, for example, be used in search and rescue and surveillance missions, monitoring in agriculture, monitoring traffic flows, aerial imaging, providing on-demand coverage in hot-spots and many other applications.

In some applications, such as surveillance or search and rescue applications, the efficiency of operation of UAVs can be enhanced if a swarm of UAVs is deployed to carry out a mission, rather than a single UAV. However, increasing the number of UAVs in a swarm may result in high aggregated data rate requirements.

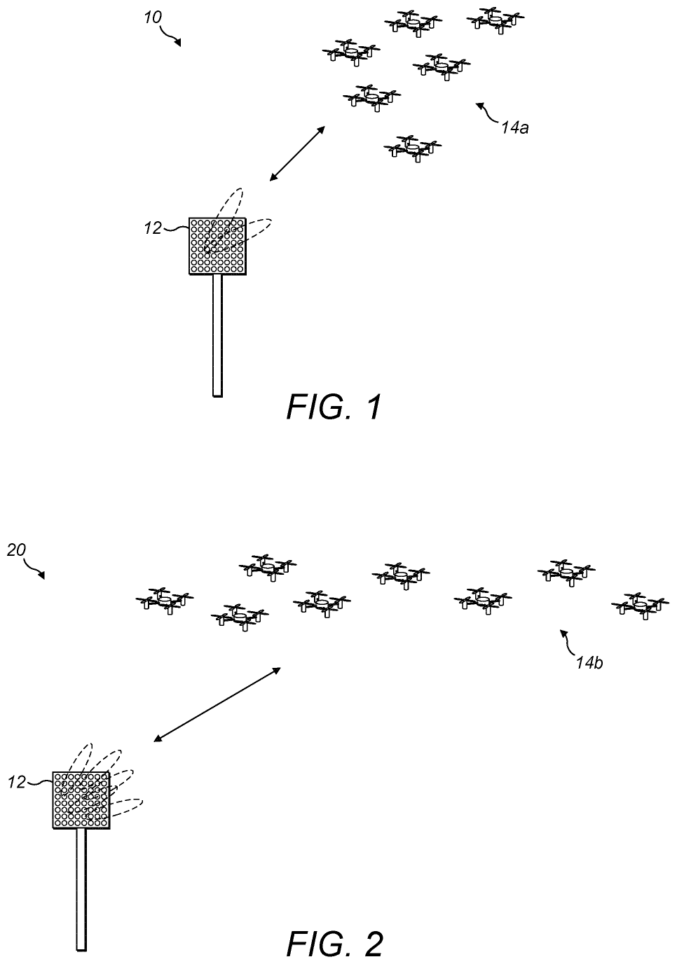

FIG. 1 is a block diagram of a system, indicated generally by the reference numeral 10, in accordance with an example embodiment.

The system 10 comprises a communication node 12 (such as a base station) and a plurality of objects 14 (such as a plurality of unmanned aerial vehicles). In the system 10, the plurality of objects 14 are organised in a swarm indicated generally by the reference numeral 14a.

Each object 14 in the plurality has a position comprising an azimuth angle and an elevation angle relative to the communication node 12. The azimuth angle and elevation angle define an angle of arrival (AoA) of communications between the communication node 12 and the respective object 14.

The communication node 12 may be a MIMO communication node having a plurality of spatially separate channels. Communications between the node 12 and the objects 14 may take place using a MIMO algorithm (e.g. a M-MIMO algorithm).

Massive multiple-input multiple-output (M-MIMO) is a candidate technology for providing wireless cellular connectivity to swarm of objects (e.g. UAVs) in applications requiring high throughput. However, realizing the benefits of M-MIMO spatial multiplexing (SM) features in applications requiring simultaneous high data rate services to a plurality of UAVs (e.g. tens of UAVs) requires addressing a number of practical challenges. For example, different UAVs to be scheduled simultaneously on the same time-frequency resources should be separated in the spatial domain; that is, they should be able to be received/served with different receive/transmit beams.

FIG. 2 is a block diagram of a system, indicated generally by the reference numeral 20, in accordance with an example embodiment. The system 20 comprises the communication node 12 and the plurality of objects 14 described above. In the system 20, the plurality of objects are organised in a swarm indicated generally by the reference numeral 14b.

The objects within the swarm 14b have been reorganised relative to the swarm 14a (i.e. provided in a different formation). As discussed further below, this reorganisation seeks to improve communication performance (e.g. MU-MIMO uplink or downlink performance) for swarm communications by leveraging a characteristic of objects such as UAVs (compared to terrestrial user devices and base stations), namely the degree of freedom in managing object locations.

As discussed in detail below, communications between the node 12 and the objects 14 (such as the objects within the swam 14b) may take place using spatial multiplexing (SM), such as the same time and frequency resources can be used for each transmission. In the context of MIMO, this may be implemented such that different objects are served by different MIMO beams (four such beams as shown schematically in FIG. 2). This is possible if each of the plurality of objects being communicated with is spatially separated, for example such that they are within different beams of a MIMO antenna of the communication node (and can therefore be served by different MIMO beams).

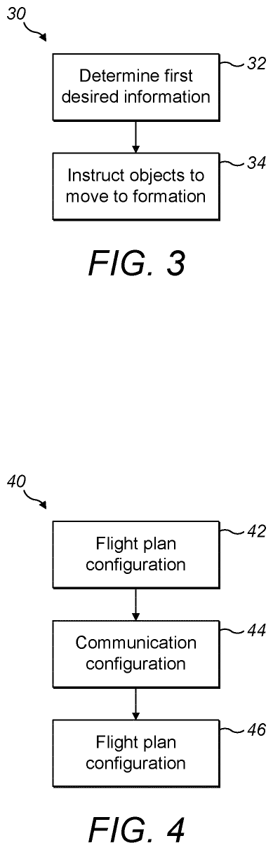

FIG. 3 is a flow chart showing an algorithm, indicated generally by the reference numeral 30, in accordance with an example embodiment.

The algorithm 30 starts at operation 32, where a first desired formation for a plurality of objects is determined. The first desired formation may be set in order to improve spatial multiplexing and/or to improve spectral efficiency of communications between the communication node 12 and the objects 14. The swarm 14b described above with reference to FIG. 2 is an example of a plurality of objects arranged in a first desired formation.

At operation 34, the objects are instructed to move to respective object positions of the first desired formation. Thus, for example, the objects may be moved from their positions in the swarm 14a to their positions in the swarm 14b.

The first desired formation may be used in a first mode of operation (e.g. a communication mode or a data transfer mode).

The location of each of the objects 14 may be defined based on azimuth and elevation relative to the communication node 12. The location may also be defined based on distance from the communication node.

FIG. 4 is a flow chart showing an algorithm, indicated generally by the reference numeral 40, in accordance with an example embodiment.

At operation 42 of the algorithm 40, the plurality of objects 14 described above are provided in a flight plan configuration. Thus, in the operation 42, the plurality of objects 14 are located according to a flight plan. This may, for example, be as shown by the plurality of objects 14a in FIG. 1.

At operation 44 of the algorithm 40, the plurality of objects are re-configured into a communication configuration (or a “data transfer” configuration). This may, for example, be as shown by the plurality of objects 14b in FIG. 2 (and may, for example, be the first formation discussed above with reference to the algorithm 30).

In operation 46 of the algorithm 40 (which may be optional in some example embodiments), the plurality of objects 14 return to the flight plan configuration.

Thus, the plurality of objects may travel in accordance with a flight plan (e.g. a predetermined flight plan), but may be repositioned into a communication (or data transfer) configuration in order for data transmission (to and/or from the objects) to take place. Such repositioning may be for a short period of time, such that once data transfer has taken place, the objects return to the original flight plan.

In some example embodiments, the communication/data transfer mode of operation is considered to represent a first mode of operation and the flight plan configuration is considered to represent a second mode of operation. In some example embodiment, the flight plan configuration is considered to represent a normal mode of operation.

It should be noted that locations of objects in the determination of the communication/data transfer mode of operation may be constrained by movement restraint limits of one or more of the plurality of objects 14 (e.g. the ability of the respective devices to move from a flight plan configuration position to a communication/data transfer mode position).

The example embodiments described herein generally consider the example case of a M-MIMO ground base station (such as the communication node 12) communicating with a UAV swarm (such as the objects 14). Consider, for example, a M-MIMO ground base station with a 2D array containing M×N antenna elements/ports, where M and N are the number of vertical and horizontal antennas, respectively. Assume that the antenna elements have horizontal and vertical spacing of λ/2, where λ is the wavelength of the carrier signal.

As noted above, a base station (such as the communication node 12) may communicate with a UAV swarm through spatial multiplexing. In other words, the base station and the P UAVs may communicate over the same time-frequency resources but on different beams.

Consider the example scenario in which a UAV swarm contains P UAVs and communicates with the ground base station in the uplink. Assume that the channels are line of sight (LOS), which is usually true for UAVs at altitudes higher than a few tens of metres (e.g. 25 metres). Denote (θₚ, ϕₚ) as the elevation and azimuth angles of arrival (AoA) of the electromagnetic waves from UAV p to the ground BS. Then, assuming that the UAVs have a single transmit antenna, the channel vector between UAV p and the ground BS denoted as hₚ∈ [symbol] ^{MN} can be written as:

hₚ=ρₚ(rₚ)a(θₚ,ϕₚ)=ρₚ(rₚ)a_{az}(ϕₚ)⊗aₑₗ(θₚ)

where ⊗ denotes the Kronecker product. ρₚ is the normalized (with respect to the noise power at the BS) uplink signal-to-noise ratio and is a function of rₚ which is the distance between the BS and UAV p.

The vectors a_{az}(ϕₚ) and aₑₗ(θₚ) are defined as

a_{az}ϕₚ)=[1,e^{jπ sin(ϕ}^{ₚ}⁾,e^{j2π sin(ϕ}^{ₚ}⁾, . . . ,e^{j(N-1)π sin(ϕ}^{ₚ}⁾]

aₑₗ(θₚ)=[1,e^{jπ sin(θ}^{ₚ}⁾,e^{j2π sin(θ}^{ₚ}⁾, . . . ,e^{j(M-1)π sin(θ}^{ₚ}⁾]

The average spectral efficiency (SE) achievable for a given object (e.g. UAV) with perfect channel state information (CSI) when a zero-forcing combiner is used at the ground base stations may be written as:

$${SE}_{p} = {log}_{2} ( 1 + \frac{1}{{[ {( {H}^{H} H )}^{- 1} ]}_{pp}} ) \qquad ( 1 )$$

where H=[h₁, . . . , hₚ] is a matrix containing the channel vectors as its columns.

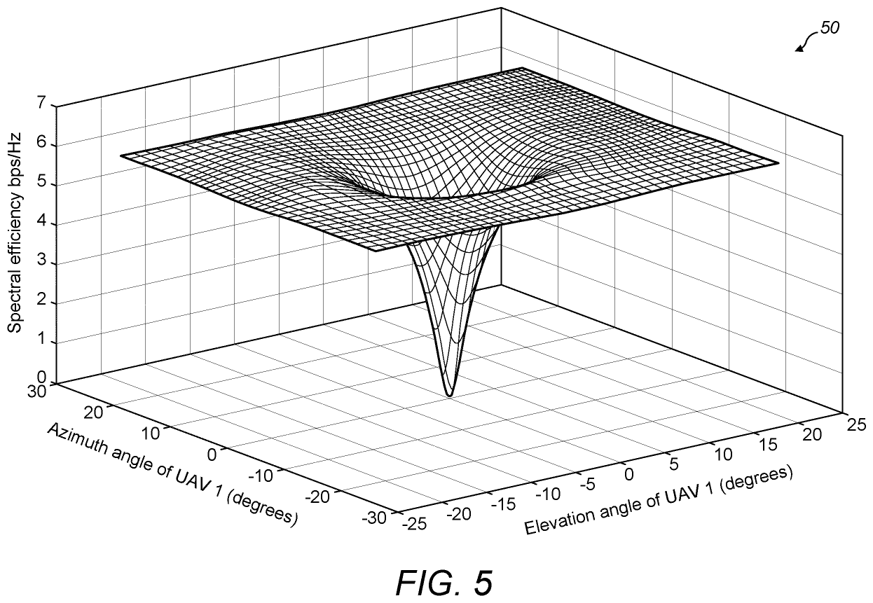

FIGS. 5 and 6 are plots, indicated generally by the reference numerals 50 and 60 respectively, showing principles in accordance with an example embodiment.

In FIGS. 5 and 6, we consider the simple case of P=2 and plot the uplink spectral efficiency of the objects (e.g. UAVs) against the azimuth and elevation AoAs of a first example UAV (UAV 1 in FIGS. 5 and 6) when a second UAV (UAV 2 in FIGS. 5 and 6) has θ₂=0° and ϕ₂=0°. Here, the base station has a rectangular array with 64 elements arranged such that M=N=8 and the parameter ρₚ is assumed to be 1 for both UAVs.

In FIG. 5, we see that the relative locations of the first and second UAVs (UAVs 1 and 2) determine the spatial multiplexing gain. In particular, when both UAVs 1 and 2 have similar angles of arrival (AoAs) with respect to the base station, i.e., when θ₁≈0 and ϕ₁≈0, the spectral efficiency of UAV 1 is close to zero, down from 6 bps/Hz when the UAVs have resolvable angles. FIG. 6 is a 2D slice of FIG. 5 when θ₂=00.

FIGS. 5 and 6 demonstrate that it may be advantageous to ensure that the UAVs are spatially resolvable at the base station in order to prevent a drop in per-UAV throughput due to a reduction in the spatial multiplexing gain. Such situations may cause problems, for example if spatial multiplexing is used to support the numerous command and control (C&C) channels in a UAV swarm.

A number of methods are discussed below for active control of the location of objects (such as UAVs) in order to seek to maximize their throughput and ensure that they are spatially separable. These methods are example implementations of the operation 32 described above. Byway of example, one or more of the following parameters may be considered:
Setting locations of the plurality of objects such that a total spectral efficiency of all of said objects is maximized.
Setting locations of the plurality of objects such that the spectral efficiency of an object of the plurality with the lowest data throughput is maximized.
Setting locations of the plurality of objects such that a spectral efficiency of each object is above a threshold level.
Setting locations of the plurality of objects such that each of the plurality of objects is spatially resolvable by the first communication node.

In a first method, the operation 32 may be implemented by optimising object (e.g. UAV) locations such that the sum-total spectral efficiency of all objects is maximized (i.e. such that the total spectral efficiency of all of said objects (e.g. UAVs) is maximised). This optimization problem can be formulated as follows:

$$( {θ}^{*} , {ϕ}^{*} ) = arg {max}_{θ , ϕ} {\sum }_{p = 1}^{P} {log}_{2} ( 1 + \frac{1}{{[ {\{ {H ( r , θ , ϕ )}^{H} H ( r , θ , ϕ ) \}}^{- 1} ]}_{( p , p )}} ) \\ subject to \\ {r}_{p} ∈ {p}_{} , ∀ p = 1 , … , P \\ {θ}_{p} ∈ {Θ}_{p} , ∀ p = 1 , … , P \\ {ϕ}_{p} ∈ {Φ}_{p} , ∀ p = 1 , … , P \qquad ( 2 )$$

where r=[r₁, . . . , r_{P}], θ=[θ₁, . . . , θ_{P}] and ϕ=[ϕ₁, . . . , ϕ_{P}] are vectors containing the distances and azimuth and elevation angles of arrival (AoAs) of all the objects, H(r, θ, ϕ) is the channel matrix in Equation (1) where the dependence on r, θ and ϕ is made explicit. The sets Rₚ, Θₚ and Φₚ are used to impose (optional) constraints on the distances and AoAs of the objects and are especially useful when the objects have physical constraints on their locations.

An alternative formulation of the optimization problem in Equation (2) is to maximize the minimum throughput across all the object (e.g. UAVs), such that the spectral efficiency of the UAV of the plurality that has the lowest data throughput in maximised. This formulation is given as follows.

$$( {θ}^{*} , {ϕ}^{*} ) = arg {max}_{θ , ϕ} min {\{ {log}_{2} ( 1 + \frac{1}{{[ {\{ {H ( r , θ , ϕ )}^{H} H ( r , θ , ϕ ) \}}^{- 1} ]}_{( p , p )}} ) \}}_{p = 1}^{P} \qquad ( 3 )$$

$$subject to \\ {r}_{p} ∈ {p}_{} , ∀ p = 1 , … , P \\ {θ}_{p} ∈ {Θ}_{p} , ∀ p = 1 , … , P \\ {ϕ}_{p} ∈ {Φ}_{p} , ∀ p = 1 , … , P$$

The formulation in Equation (3) ensures fairness across all the objects by maximizing the spectral efficiency (SE) of the object with the lowest throughput. In other words, the formulation in Equation (2) may result in a solution where some objects have high spectral efficiencies and others have low spectral efficiencies, whereas the formulation in Equation (3) prevents this condition and ensures that all objects tend to have similar throughputs. Such a characteristic may be desirable in the ultra-reliable low-latency communication (URLLC) context where we want to ensure that the communication to every object meets certain latency and reliability requirements.

Note that the optimization problems in Equations (2) and (3) are non-convex and consequently, it is difficult to find the globally optimal solution in practice. However, methods such as projected gradient descent and projected sub-gradient can find locally optimal solutions. Additional approaches such as simulated annealing can be used to improve the quality of the local minima and increase the possibility of finding the global minima.

Rather than maximizing the sum-total or minimum spectral efficiency, an alternative sub-optimal approach to the formulation in equations (2) and (3) is to position the objects (e.g. UAVs) such that they are always spatially resolvable at the base station (e.g. communication node 12). This idea is both conceptually simple and easy to implement.

In more formal terms, for a given base station antenna configuration and for every pair of objects p and q, we can find parameters ϵ_{η} and Δ_{η} such that the throughputs are greater than a pre-determined threshold η when the separation in azimuth and elevation is greater than ϵ_{η} and Δ_{η}, respectively, i.e.,

SEₚ≥η and SE_{q}≥η when |θₚ−θ_{q}|ϵ_{η} and

|ϕₚ−ϕ_{q}|≥Δ_{η}

The parameters ϵ_{η} and Δ_{η} can be found by evaluating the spectral efficiency expression in Equation (1) for different azimuth and elevation angles and comparing it with the threshold η. For instance, in FIG. 6, it can be seen that for SE₁ and SE₂ to be greater than η=4 bps/Hz, the difference in azimuth angle between the UAVs should be at least 5 degrees.

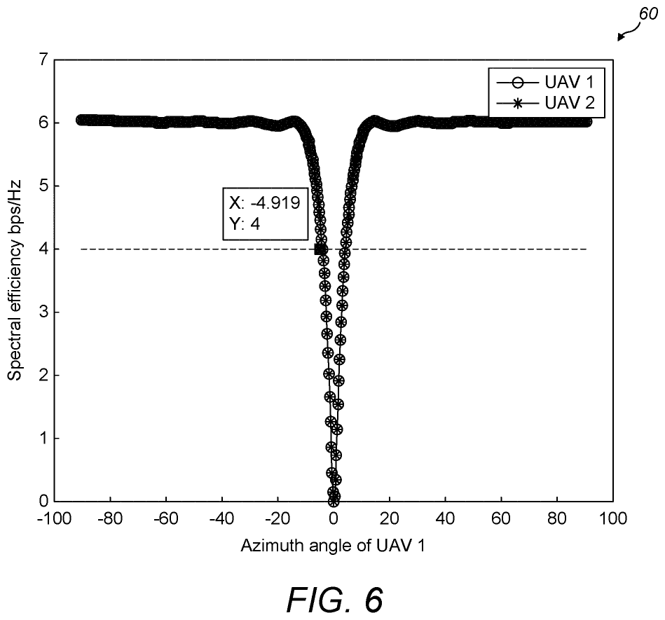

The proposed approach involves continuously optimizing the object (e.g. UAV) trajectory such that the condition |θₚ−θ_{q}|≥ϵ_{η} and |ϕₚ−ϕ_{q}|Δ_{η} is always satisfied. A flowchart of an example implementation of this method is shown in FIG. 7.

FIG. 7 is a flow chart showing an algorithm, indicated generally by the reference numeral 70, in accordance with an example embodiment.

The algorithm 70 starts at operation 71, where current location data and flightpath information is obtained for each of a plurality of UAVs (or some other objects) in a swarm. The location data may be obtained, for example, from on-board navigation systems (e.g. GPS or inertial navigation system), cellular-based navigation systems, a UAV traffic controller or in some other way.

At operation 72, azimuth and elevation angles (θ, ϕ) between a communication node (such as the communication node 12) and each of the plurality of UAVs is determined. The operation 72 may be implemented based on the data obtained in the operation 71 and a known location of the relevant communication node.

At operation 73, possible locations for the UAVs of the swarm that meet defined requirements are determined. For example, for each pair of UAVs of the plurality (p and q), we may determine the parameters ϵ_{η} and Δ_{η} (that is, the difference in elevation of azimuth angles—based on the data determined in operation 72) such that defined UAV-specific spectral efficiency targets are fulfilled.

As discussed above, example spectral efficiency targets include: SEₚ≥η and SE_{q}≥η when |θₚ−θ_{q}|≥ϵ_{η} and |ϕₚ−ϕ_{q}|≥Δ_{η}.

The operation 73 may be an iterative process and may generate multiple combinations of UAV swarm constellations that constitute different location options that meet the defined requirements.

At operation 74, trajectory updates for the UAVs of the swarm are selected. The trajectory option selected may, for example, be the option generated in the operation 73 that involves the minimum deviation from the original flight path. In this way, both power consumption and latency can be improved. The skilled person will be aware of alternative implementations of the operation 74.

The operations 71 to 74 of the algorithm 70 are an example implementation of the operation 32 of the algorithm 30 described above. Thus, the formation selected in operation 74 is an example of the first desired formation determined in operation 32.

At operation 75, the trajectories selected in operation 74 are used to modify UAV locations. The operation 75 may be implemented by uploading flight control information to the UAVs of the swarm. The operation 75 is an example implementation of the operation 34 of the algorithm.

Once the operation 75 is complete, the UAVs of the swarm may be in a formation suitable for data transmission. At operation 76, data may be transferred (e.g. from one of more of the UAVs to the relevant communication node and/or from the communication node to one or more of the UAVs).

As described above with reference to the algorithm 40, once data has been transferred, the UAVs may return to locations of in accordance with their original flightpaths. Thus, in optional operation 77, the UAVs may revert to the original flight plan. The operation 77 may be omitted in some example embodiments.

In one example embodiment of the invention, the above-mentioned methods to optimize the locations of UAVs (or other objects) can be extended to take into account also swarm-external known interference sources (in case of UAV uplink communications) and/or vulnerable receivers (in case of UAV downlink communications). This could be implemented, for example, by utilizing spatial (location and/or orientation), antenna capability, and transmit power information of the potential interference sources and/or vulnerable receivers to set additional constraints for the optimization.

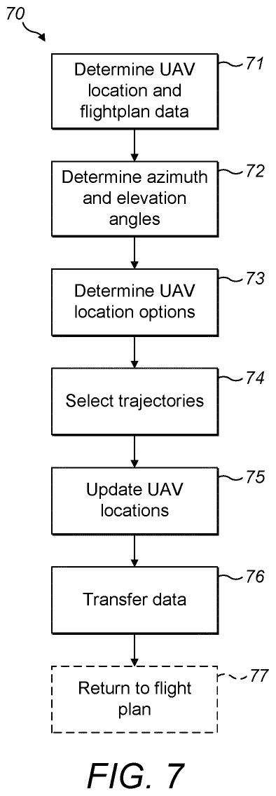

FIG. 8 is a block diagram of a system, indicated generally by the reference numeral 80, in accordance with an example embodiment.

The system 80 comprises a first communication node 81 (such as a first base station), a second communication node 82 (such as a second base station) and a plurality of objects 84 (such as a plurality of unmanned aerial vehicles (UAVs)). In the system 80, the plurality of objects 84 are organised in a swarm.

As discussed above, the communication nodes 81 and 82 may be MIMO communication nodes each having a plurality of spatially separate channels.

The system 80 shows a situation in which the objects (e.g. UAVs) of the swarm 84 may remain spatially unresolvable by a single communication node (i.e. by either one of the communication nodes 81 and 82). This may, for example, be due to limitations of individual objects in re-positioning themselves because of constraints put on their instantaneous trajectories or flight paths. In such conditions only limited amount of spatial multiplexing gain may be possible without co-operation with additional communication nodes.

The system 80 enables the enhancement of overall spectral efficiency by dividing the spatially-unresolvable objects (e.g. UAVs) into two or more groups, wherein each of said groups are in communication with a different node. Thus, in the system 80, some of the objects 84 are in communication with the first communication node 81 and some of the objects 84 are in communication with the second communication node 82. A serving base station (e.g. gNB) or some other network control unit may coordinate and manage the associated information exchange among base stations. Different implementation options are possible.

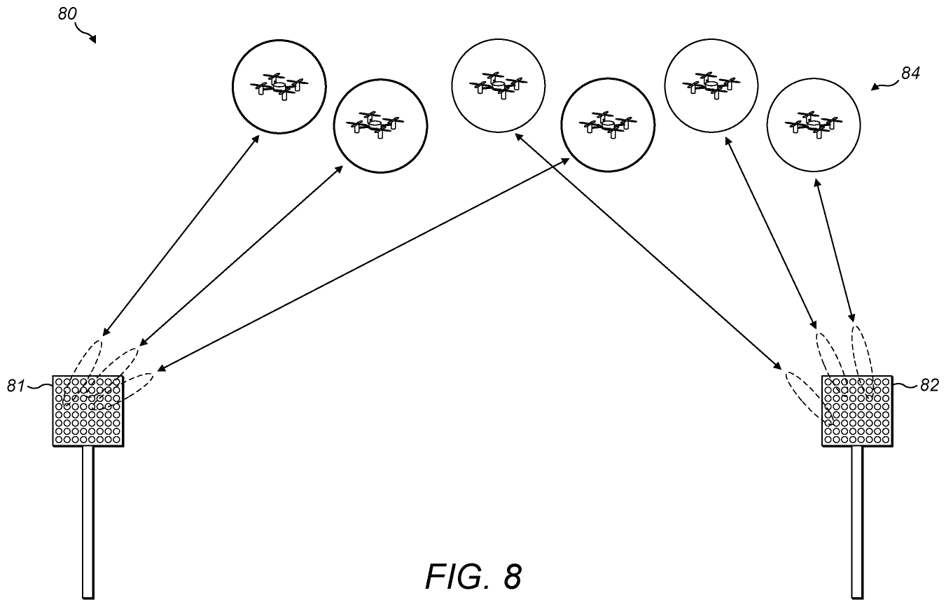

FIG. 9 is a flow chart showing an algorithm, indicated generally by the reference numeral 90, in accordance with an example embodiment.

The algorithm 90 starts at operation 92, where a pair of spatially unresolvable objects (e.g. UAVs) is identified.

At operation 94, a determination is made (e.g. by a network control unit or some similar module) whether a suitable second node (such as the second communication node 82 in the example system) is available. The operation 94 may be implemented utilizing the spatial information and the antenna configuration data of the other co-operating communication nodes (such as the node 81) to determine if there is a co-operating base station that could serve the spatially-unresolvable pair of objects in their current positions or if there is a co-operating base station that could serve the spatially-unresolvable pair of objects with trajectory updates that fulfil the constraints put on instantaneous trajectories/flight paths of respective objects.

If a second node is identified, then the algorithm 90 moves to operation 96 where that second node is used for communications.

If a second node is not identified, then the algorithm 90 moves to operation 98, where 35 an orthogonal resource (e.g. a different time or frequency) is used for communications with one of the spatially-unresolvable pair of objects.

The invention can also be utilized in scenarios comprising different UAVs (or multiple UAV swarms in generalized case) coordinated by different UAV operators. More specifically, let us assume an example scenario in which there are two UAV swarms being coordinated by two different UAV operators and that the UAV swarms would have independently specified mission-specific trajectories with instantaneous waypoints showing close proximity in 3-dimensional space. Moreover, let us also assume that there would be a need to schedule these UAV swarms simultaneously in downlink or uplink.

In case where both UAV swarms are served by the same gNB or transmission and reception point (TRP), the UAV position optimization procedure 90 described above could be directly leveraged to determine trajectory updates for the individual UAVs such that they can be simultaneously served in MU-MIMO with spatially-resolvable beams in their respective updated 3D positions. In this case, the interaction and the potential inter-swarm interference is addressed either by extending the set of UAV P, to include UAVs of both swarms or treating the spatial directions of the UAVs of the potentially interfering/vulnerable swarm as “keep-out” directions when optimizing the locations of UAVs of the other swarm.

In a case where different UAV swarms are served by different gNB/TRPs, the network can intervene and determine trajectory updates for the UAVs such that collisions of UAV downlink beams from different gNB/TRPs can be avoided at UAV receivers or alternatively the UAV uplink interference at gNB/TRP receivers can be minimized. This may be important assuming single-antenna (omni-directional) UAV receivers, transmitters, respectively. This case is similar to that of serving the spatially unresolvable UAVs of the same swarm by multiple communication nodes (as described above). In this case, the mutual interference management solution is constructed by joint optimization which guarantees spatial resolvability of UAVs within individual swarms from their respective gNB/TRP antenna array, subject to simultaneously avoiding beam collision between different gNB/TRPs serving the different swarms.

In the specific case where close-proximity UAVs have strict constraints on their original trajectories, preventing beam collision by means of temporary updates in their positions, orthogonalization of resource allocations among the different colliding beams can be used.

Yet another solution to the multi-UAV-operator situation can be devised by adapting the above-presented UAV position optimization algorithm in a way that it yields updated UAV trajectories such that close-proximity UAVs can be served simultaneously with the same transmit/receive beam from a single communication node with orthogonal resource allocation in frequency (subject to additional trajectory design constraints avoiding mutual obstruction between UAVs with respect to the serving communication node).

In some example embodiments, determination of trajectory updates of objects (e.g. UAVs) for optimization of swarm formation, may require signalling and/or exchange of information on (ground or aerial) communication node antenna configurations, including but not limited to data on location, orientation, array geometry, elevation and azimuth angle range supported, between different nodes across of the core network

In some example embodiments, handover of spatially-unresolvable objects (e.g. UAVs) to other co-operating (ground or aerial) communication nodes may require signalling of information on the respective objects, such as UE IDs, flightpaths/current trajectories, between co-operative communication nodes and/or control unit.

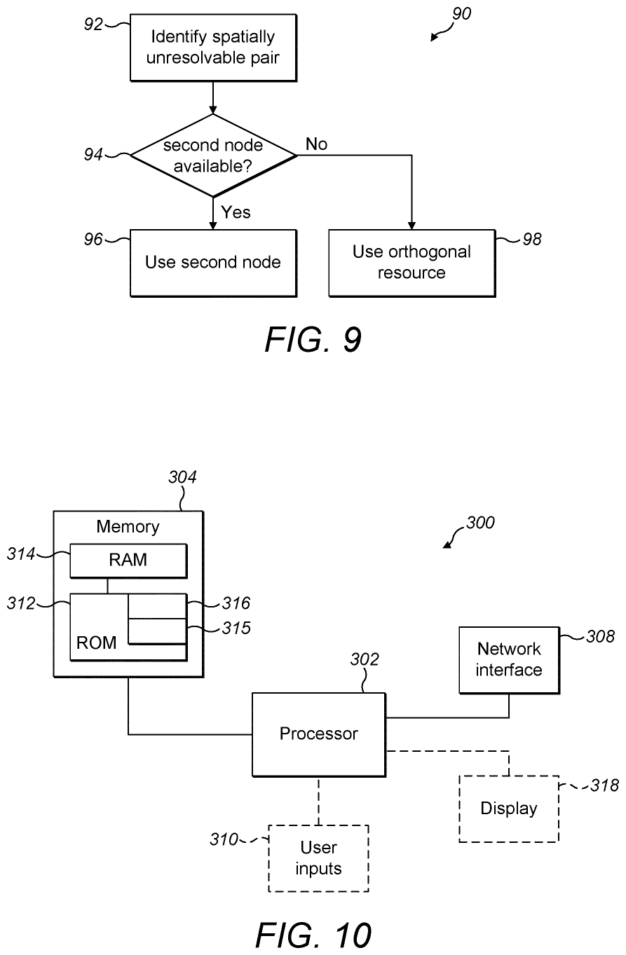

For completeness, FIG. 10 is a schematic diagram of components of one or more of the example embodiments described previously, which hereafter are referred to generically as a processing system 300. The processing system 300 may, for example, be the apparatus referred to in the claims below.

The processing system 300 may have a processor 302, a memory 304 closely coupled to the processor and comprised of a RAM 314 and a ROM 312, and, optionally, a user input 310 and a display 318. The processing system 300 may comprise one or more network/apparatus interfaces 308 for connection to a network/apparatus, e.g. a modem which may be wired or wireless. The interface 308 may also operate as a connection to other apparatus such as device/apparatus which is not network side apparatus. Thus, direct connection between devices/apparatus without network participation is possible.

The processor 302 is connected to each of the other components in order to control operation thereof.

The memory 304 may comprise a non-volatile memory, such as a hard disk drive (HDD) or a solid state drive (SSD). The ROM 312 of the memory 304 stores, amongst other things, an operating system 315 and may store software applications 316. The RAM 314 of the memory 304 is used by the processor 302 for the temporary storage of data. The operating system 315 may contain code which, when executed by the processor implements aspects of the algorithms 30, 40, 70 and 90 described above. Note that in the case of small device/apparatus the memory can be most suitable for small size usage i.e. not always a hard disk drive (HDD) or a solid state drive (SSD) is used.

The processor 302 may take any suitable form. For instance, it may be a microcontroller, a plurality of microcontrollers, a processor, or a plurality of processors.

The processing system 300 may be a standalone computer, a server, a console, or a network thereof. The processing system 300 and needed structural parts may be all inside device/apparatus such as IoT device/apparatus i.e. embedded to very small size.

In some example embodiments, the processing system 300 may also be associated with external software applications. These may be applications stored on a remote server device/apparatus and may run partly or exclusively on the remote server device/apparatus. These applications may be termed cloud-hosted applications. The processing system 300 may be in communication with the remote server device/apparatus in order to utilize the software application stored there.

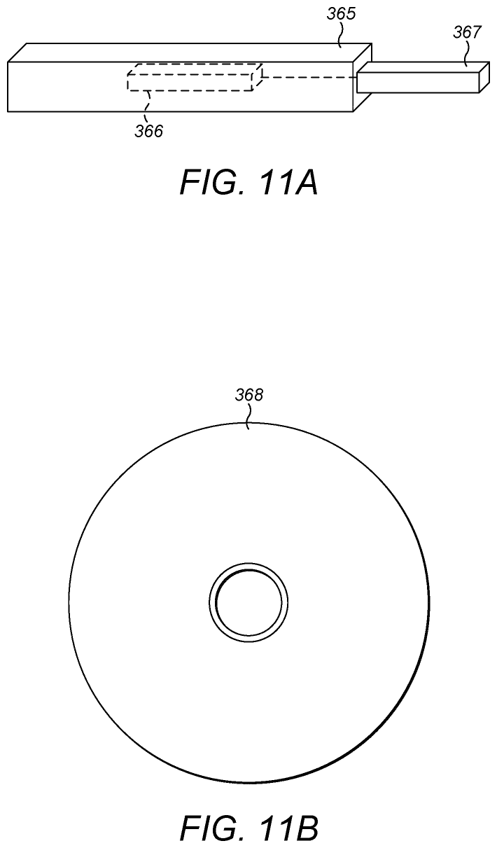

FIGS. 11A and 11B show tangible media, respectively a removable memory unit 365 and a compact disc (CD) 368, storing computer-readable code which when run by a computer may perform methods according to example embodiments described above. The removable memory unit 365 may be a memory stick, e.g. a USB memory stick, having internal memory 366 storing the computer-readable code. The internal memory 366 may be accessed by a computer system via a connector 367. The CD 368 may be a CD-ROM or a DVD or similar. Other forms of tangible storage media may be used. Tangible media can be any device/apparatus capable of storing data/information which data/information can be exchanged between devices/apparatus/network.

Embodiments of the present invention may be implemented in software, hardware, application logic or a combination of software, hardware and application logic. The software, application logic and/or hardware may reside on memory, or any computer media. In an example embodiment, the application logic, software or an instruction set is maintained on any one of various conventional computer-readable media. In the context of this document, a “memory” or “computer-readable medium” may be any non-transitory media or means that can contain, store, communicate, propagate or transport the instructions for use by or in connection with an instruction execution system, apparatus, or device, such as a computer.

Reference to, where relevant, “computer-readable medium”, “computer program product”, “tangibly embodied computer program” etc., or a “processor” or “processing circuitry” etc. should be understood to encompass not only computers having differing architectures such as single/multi-processor architectures and sequencers/parallel architectures, but also specialised circuits such as field programmable gate arrays FPGA, application specify circuits ASIC, signal processing devices/apparatus and other devices/apparatus. References to computer program, instructions, code etc. should be understood to express software for a programmable processor firmware such as the programmable content of a hardware device/apparatus as instructions for a processor or configured or configuration settings for a fixed function device/apparatus, gate array, programmable logic device/apparatus, etc.

If desired, the different functions discussed herein may be performed in a different order and/or concurrently with each other. Furthermore, if desired, one or more of the above-described functions may be optional or may be combined. Similarly, it will also be appreciated that the flow diagrams and message sequences of FIGS. 3, 4, 7 and 9 are examples only and that various operations depicted therein may be omitted, reordered and/or combined.

It will be appreciated that the above described example embodiments are purely illustrative and are not limiting on the scope of the invention. Other variations and modifications will be apparent to persons skilled in the art upon reading the present specification.

Although the examples described above relate to UAV uplink and/or downlink communications, the principles described herein can be applied to other example applications. For example, the use of UAV swarms comprising a M-MIMO-enabled master UAV as an aerial base station in addition to other single-antenna UAVs is possible. Moreover, the principles can be applied to non-UAV applications, such as the control of automated factory floors having a plurality of mobile robots.

Moreover, the disclosure of the present application should be understood to include any novel features or any novel combination of features either explicitly or implicitly disclosed herein or any generalization thereof and during the prosecution of the present application or of any application derived therefrom, new claims may be formulated to cover any such features and/or combination of such features.

Although various aspects of the invention are set out in the independent claims, other aspects of the invention comprise other combinations of features from the described example embodiments and/or the dependent claims with the features of the independent claims, and not solely the combinations explicitly set out in the claims.

It is also noted herein that while the above describes various examples, these descriptions should not be viewed in a limiting sense. Rather, there are several variations and modifications which may be made without departing from the scope of the present invention as defined in the appended claims.

1. An apparatus, comprising:
at least one processor; and
at least one memory including computer program code, the at least one memory and computer program code being configured, with the at least one processor, to cause the apparatus to perform:
determining a first desired formation for a plurality of objects in accordance with a communication performance algorithm, wherein the plurality of objects are in communication with a first communication node and wherein the plurality of objects are unmanned aerial vehicles, unmanned ground vehicles or robots; and
instructing the objects of the plurality to move to respective object positions of the first desired formation in a first mode of operation, wherein the first mode of operation is a data transfer mode of operation,
wherein determining the first desired formation comprises one or more of:
optimizing locations of the plurality of objects such that the spectral efficiency of an object of the plurality with the lowest data throughput is maximized;
optimizing locations of the plurality of objects such that a spectral efficiency of each object is above a threshold level; and
setting the first desired formation of the plurality of objects such that each of the plurality of objects is spatially resolvable by the first communication node.

2. The apparatus as claimed in claim 1, wherein determining the first desired formation comprises optimizing locations of the plurality of objects such that a total spectral efficiency of all of said objects is maximized.

3-5. (canceled)

6. The apparatus as claimed in claim 1, wherein the means-for-determining the first desired formation is constrained by movement restraint limits of one or more of the plurality of objects.

7. The apparatus as claimed in claim 1, wherein the at least one memory and computer program code are further configured, with the at least one processor, to cause the apparatus to perform dividing the objects into two or more groups, wherein each of said groups are in communication with a different communication node.

8. (canceled)

9. The apparatus as claimed in claim 1, wherein the at least one memory and computer program code are further configured, with the at least one processor, to cause the apparatus to perform instructing the objects to move to respective object positions in accordance with a flight plan in a second mode of operation.

10. The apparatus as claimed in claim 1, wherein each object position comprises an azimuth angle and an elevation angle of the respective object relative to the first communication node.

11. The apparatus as claimed in claim 1, wherein the at least one memory and computer program code are further configured, with the at least one processor, to cause the apparatus to perform communicating between the first communication node and the plurality of objects using a MIMO algorithm.

12. (canceled)

13. The apparatus as claimed in claim 1, wherein the first communication node communicates with the plurality of objects using spatial multiplexing.

14. (canceled)

15. A method, comprising:
determining a first desired formation for a plurality of objects in accordance with a communication performance algorithm, wherein the plurality of objects are in communication with a first communication node, and wherein the plurality of objects are unmanned aerial vehicles, unmanned ground vehicles or robots; and
instructing the objects of the plurality to move to respective object positions of the first desired formation in a first mode of operation, wherein the first mode of operation is a data transfer mode of operation,
wherein determining the first desired formation comprises one or more of:
optimizing locations of the plurality of objects such that the spectral efficiency of an object of the plurality with the lowest data throughput is maximized;
optimizing locations of the plurality of objects such that a spectral efficiency of each object is above a threshold level; and
setting the first desired formation of the plurality of objects such that each of the plurality of objects is spatially resolvable by the first communication node.

16. A computer program embodied on a non-transitory computer-readable medium, said computer program comprising instructions for causing an apparatus to perform at least the following:
determining a first desired formation for a plurality of objects in accordance with a communication performance algorithm, wherein the plurality of objects are in communication with a first communication node, and wherein the plurality of objects are unmanned aerial vehicles, unmanned ground vehicles or robots; and
instructing the objects of the plurality to move to respective object positions of the first desired formation in a first mode of operation, wherein the first mode of operation is a data transfer mode of operation,
wherein determining the first desired formation comprises one or more of:
optimizing locations of the plurality of objects such that the spectral efficiency of an object of the plurality with the lowest data throughput is maximized;
optimizing locations of the plurality of objects such that a spectral efficiency of each object is above a threshold level; and
setting the first desired formation of the plurality of objects such that each of the plurality of objects is spatially resolvable by the first communication node.
